(19) United States
(12) Patent Application Publication
(10) Pub. No.: US 2006/0141437 A1
(43) Pub. Date: Jun. 29, 2006

(54) Encoding and decoding system for making and using interactive language training and entertainment materials

(76) Inventor: Carl Isamu Wakamoto, Tarzana, CA (US)

Correspondence Address: DAVID S. NAGY, 756 S. GRIFFITH PARK DR., BURBANK, CA, 91506, US

(21) Appl. No.: 11/021,853

(22) Filed: Dec. 23, 2004

(51) Int. Cl. G09B 5/04

(52) U.S. Cl. 434/319

(57) ABSTRACT

This invention is a system for interactive learning for language and other studies, providing an immersion experience with other students. Program material, which can be easily and inexpensively recorded by teachers, students and other users, is encoded to make it interactive when it is decoded upon playback, in such a way that the part that the student is to speak, sing or play is played back through the student's headphones, prompting the student to perform the part properly in response to on-screen action, while the rest of the program material's audio, such as other characters' dialogue, is played back through a loudspeaker. The student-performed part is then recorded, so that upon playback the student can see how his or her efforts sound, compare with the original and/or mesh with the rest of the program. This permits the user to write dialogues, skits, words, expressions, lyrics, etc., to record them, and use the recordings for effective interactive voice training. These encoded pieces can be exchanged with other users, even via the internet across the world, to promote linguistic and cultural exchange and understanding.

### BACKGROUND OF THE INVENTION

English conversation and other forms of language study have become popular in recent years; with increased tension throughout the world, understanding of foreign languages and cultures is more important than ever before. Both government agencies, such as the departments of Defense and State, and private industry are in desperate need of foreign language speakers. Various types of practice device and method have hitherto been employed for language study. Practice face-to-face with a teacher is the most common method, but systems which permit practice at home either individually or in small groups are also effective. The video-player is very popular in the ordinary home, but it is normally used for recording broadcast programs or playing rented videos, and its use is limited if applied to the study of English (or other language) conversation without further modification, even with the use of specifically produced language training videos. The problem is that practice becomes one-sided, and it is impossible to practice living conversation enjoyably. Moreover, it is not very effective.

Recent years have seen the emergence of new storage media such as CDs, DVDs, and hard drives in computers as well as DVRs, but no new proposals have been made for their use as effective language or singing practice devices.

This was all changed by the development of the inventions that are the subjects of U.S. Pat. Nos. 5,810,598, 6,283,760 and 6,500,006, all by this same inventor. These permitted the suppression of selected dialogue or vocals ordinarily heard through a loudspeaker, and routing the suppressed dialogue or vocals to a headphone, instead, so that during the blank spaces the student or singer is prompted with his or her responses, and given the proper pronunciation or melody.

### BRIEF SUMMARY OF THE INVENTION

This invention is an improved device and method for interactive language study, musical training and performance assistance, and general entertainment using audio-visual programs. It builds upon the basic concepts of the inventor's previous patents, starting by allowing the suppression and re-routing of the selected dialogue or vocals to be achieved without having to record multiple variations of the original performance template for each character whose dialogue is to be suppressed and re-routed. This invention involves processing the program material so as to permit the user to direct that certain portions of the program material are routed to one location, and other portions to another, for example: the user, a language student or aspiring actor, might watch a movie on a television set, with all of the audio except the dialogue of one character—the character being “played” by the user—being routed through the TV, but with the dialogue of this one character instead being routed through headphones. Thus, the user can be prompted by a model performance to supply his or her own performance. This performance of the user is then recorded, and played back subsequently for the user's edification—to judge his or her performance—or general amusement—dubbing his or her own voice in place of the original actor's.

The same process can be applied to singalongs, where the ability to be prompted by a model performance routed through headphones, but not audible to the audience, can be an invaluable aid in jogging the user's recollection of the lyrics, rhythm and melody of the song being performed, and will help remind the user of the proper pitch. It can thus easily be seen that these inventions can increase the enjoyment and reduce the potential for embarrassment of singers by helping to minimize singers' mistakes. By the same token, and for these same reasons, these inventions are also helpful to instrumentalists learning or performing music.

The particular innovation of this invention is improved functionality, flexibility, controllability and ease of operation of this process.

### BRIEF DESCRIPTION OF THE SEVERAL VIEWS OF THE DRAWING

FIG. 1. This depicts the encoding function of this invention. The audio and video outputs of an audio-visual (A/V) signal source, e.g., a camcorder, DVD, computer, etc., are connected to a variable-speed playback source, which can allow the signal to pass through unaltered or at an altered speed, most helpfully slowed down (this function can be performed mechanically or through software, and could be incorporated in the signal source unit). The video out therefrom goes to an A/V recorder—video CD recorder, DVD recorder, DVR, VCR, computer, etc.—while the audio output therefrom goes to channel 1 of an audio mixer. The audio output of a music and effects (M&E) source—background music, foley sound effects, etc.—goes to channel 2 of the audio mixer, whence it is fed to both of the mixer's outputs, while the channel 1 input is only fed to one output, here shown as the left. The audio mixer's outputs go to the audio inputs of the A/V recorder, which also receives closed captions and/or subtitles from a closed caption/subtitle generator.

FIG. 2. This depicts the decoding function of the invention. The drawing shows the video output from a signal source (DVD, VCR, Computer, etc.) going to an A/V recorder, and thence to a video monitor. The left and right audio outputs of that signal source go to a DPDT switch D, where they are either passed through to switch outputs E and F in the same orientation or reversed, depending on the setting of the switch, i.e., left to E and right to F in one switch setting, and left to F and right to E in the other. Output E goes to the input of a headphone amplifier and thence to a headphone P in a headset S, to be worn by a practitioner (not depicted) of this invention—when accommodating more than one practitioner at a time, it is most helpful if the headphone amplifier has a separate volume control for each headphone output. Headset S contains a microphone M to pick up the practitioner's speech, which goes to both the left and right channels of INPUT 1 of an audio mixer, while output F from switch D goes to the left and right channels of INPUT 2 of the audio mixer. The audio mixer permits the user to balance the gain, tone, etc., of the sound from the microphone with that from the signal source. The left and right output of the audio mixer go to the A/V Recorder and on one or more speakers, either freestanding or incorporated in the monitor.

FIG. 3. Shows a microphone-and-headphone combination, where microphone M is connected to headphone P by headphone cable PC, and joint or conjoined microphone-and-headphone cable MPC carries both the microphone's output and the headphone's input. Headphone P is shown as mounting on the ear, but can be adapted to be worn over the head or in any other practical manner.

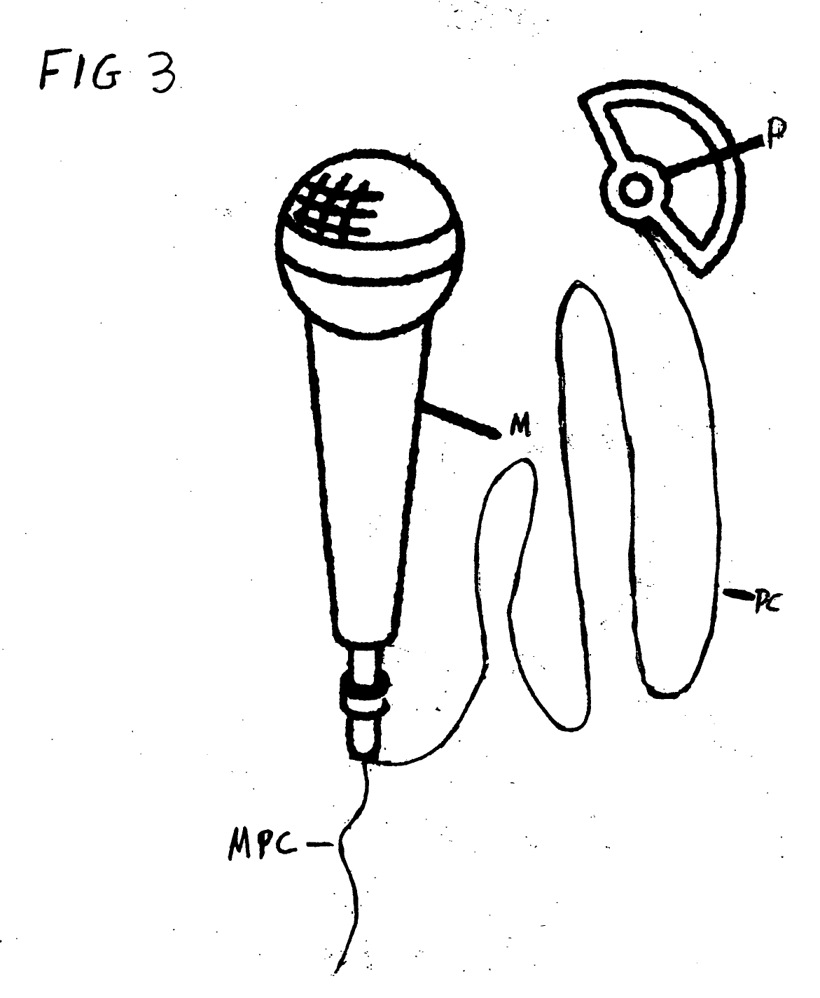

### DETAILED DESCRIPTION OF THE INVENTION

While total immersion in a foreign language and culture is demonstrably the quickest and best way to learn a foreign language, few people can afford to move to a foreign country just to acquire such a skill; in fact, in business situations, acquiring language proficiency is frequently the prerequisite for such a move.

The original purpose of this series of inventions was to improve upon the current state of the art, by making it more interesting, varied, helpful and instructive. This was accomplished, as described in the above-referenced Patents whose disclosures are hereby incorporated by reference, by processing audio or audio-visual material so as to allow not just the suppression of portions of the dialogue from going through the normal audio system (e.g., the loudspeakers of a TV or tape player), but also the ability to route the suppressed dialogue through an alternate audio system (e.g., headphones), so as to permit the student to interact with the recorded conversation by speaking the suppressed dialogue while also being prompted with that same dialogue, correct and properly pronounced, through headphones. In addition, with an audio-visual application it is possible to include subtitles and/or closed captions: for all dialogue, just for the character being “performed” by the student, selectively for other characters instead or as well, or any other combination and variation, including the option to toggle any subtitling function on and off. The subtitles can be generated and/or synchronized to the on-screen action by a variety of means, for example voice-recognition or other technology already in existence. Such technology could also be employed to analyze the student's performance and to compare it to the original performance; the student could be given a “grade” of his or her performance, a readout of the strengths and weaknesses of the performance, etc. Subtitles could be made even more effective when used for multiple characters by differentiating them from each other through the use of different typefaces (regular/italic/bold, Times Roman/Arial/Courier, etc.) or other means. A further improvement relating to such a subtitling function is to allow the selection of any words used in the “script,” which applies to both the subtitled character being performed by the student or any other vocabulary of all the characters, to be selected for use in vocabulary training, so that, for example, the selected words would provide a pool from which a word for the game “hangman” could be randomly selected; such a function is particularly easily provided in a software-based iteration of the invention.

The basic invention is practiced in its simplest form by recording a conversation between two characters, with one microphone recording one character's dialogue on one recording channel, and another microphone recording the other character's dialogue on another recording channel. Then, upon playback, one channel is fed to one or more loudspeakers, while the other is fed to a headphone worn by the user. The user hears this dialogue through his or her headphone and is thereby prompted to speak it him- or herself, in “response” to the dialogue of the other character heard through the loudspeakers. It is, of course, recognized that headphones of necessity contain loudspeakers, as well, but for the sake of clarity this description will refer to as “loudspeakers” only those speakers designed to produce audio intended to be heard by more than one person. This headphone ideally has a single earpiece, so that the user can hear the loudspeakers with his or her other ear, and this earpiece is preferably worn over the left ear, as this ear has been shown to have the more direct connection to the right brain hemisphere, which is the hemisphere that controls language and speech functions. Of course, it is also possible to use stereo headphones, with one or both earpieces worn partially off the ear(s). A headset such as those worn by telephone operators, combining a headphone with a microphone attached to it on a rigid stalk, is helpful. One particularly effective variation on this theme is to have the microphone connected to the headphone by means of a semi-rigid stalk, such as a gooseneck; this is especially useful in the singalong application, where one can have a “conventional”, cylindrical microphone mounted at the end of such a gooseneck, allowing the singer to grasp the mike in the manner of classic rock singers, while not being limited by its being on a mike stand, nor having to hold it all the time. Alternatively, the cables of the headphone and the microphone can be physically joined up to a certain point near the user, where the respective cables would diverge so as to allow sufficient flexibility in positioning the microphone while also minimizing the potential for cord tangling. As another alternative, the headphone and/or microphone could also employ wireless technology. Furthermore, and especially attractively for use by children, the headphone and microphone could be contained in a doll, action figure or other toy, for example with the speaker in the figure's mouth and the microphone in the figure's appropriately posed hand.

Also, it should be noted that it is of course possible to practice this invention with more than two characters and microphones and channels, and also that it is not necessary to employ more than one microphone: the various characters could all speak into one microphone, with the output of that microphone being selectively routed to the channel appropriate that character. It is also possible to practice the invention with just a monologue, for example having a parent read a children's story for child to chime in with on playback.

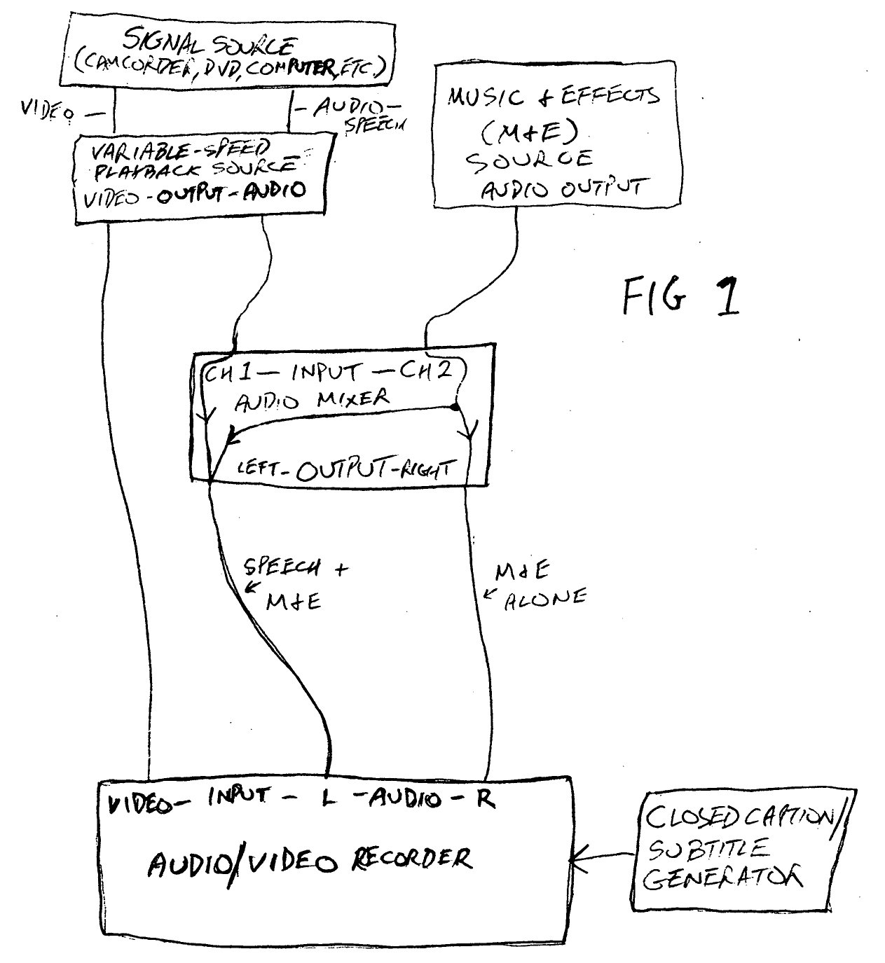

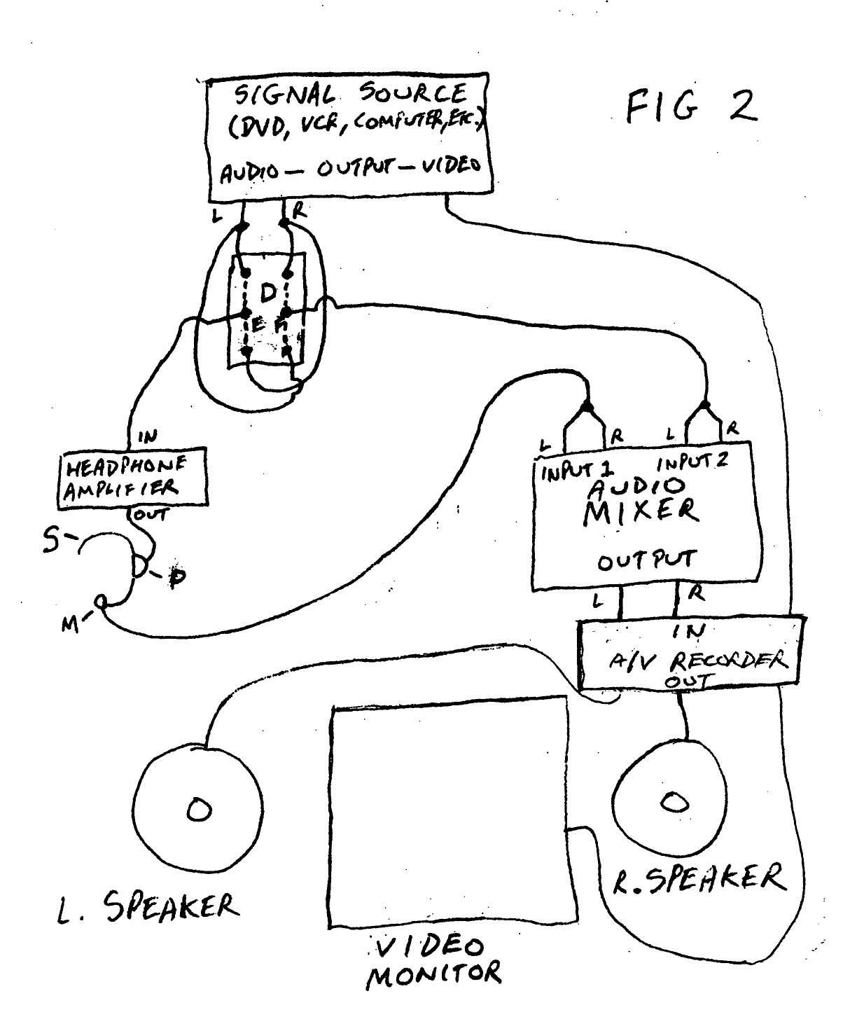

Also, it is not necessary to employ more than a single channel, as it may be desirable and simple, especially in the case where the characters' dialogue does not overlap (and for instruction purposes it is best to not have the dialogue overlap, anyway), to record them all on a single channel. This audio is then encoded, as in FIG. 1, by adding in music and sound effects (“M&E”) to stereo audio, so that the M&E ends up on both channels, while the conversation ends up on just one channel, for example the left. Then, upon playback, the audio is decoded, as in FIG. 2, one channel is fed to a headphone worn by the user who speaks the dialogue of one of the characters in the conversation (for example the first character), while the other is fed to one or more loudspeakers. When the first character is speaking, the user sets a double-pole-double-throw A/B switch to route the left channel through a headphone worn by the user, while the right channel is routed to loudspeakers. The user hears this dialogue through his or her headphone, along with the M&E, and is this or hereby prompted to speak it him- or herself, while the M&E also comes through the loudspeakers. When the second character is speaking on the program material, the DPDT switch is set to the reverse position, sending the right channel to the headphone and the left channel to the loudspeakers, so that the second character's dialogue comes through the loudspeakers along with the M&E, while M&E alone comes through the headphone.

Additionally, some A/B switches consist of a pair of push-buttons (often labeled, not surprisingly, “A” and “B”), where pressing one button engages one connection—e.g., Ch. 1 to the loudspeaker, and Ch. 2 to the headphones—and disengages the other button; pressing the other button engages the opposite connection and disengages the first button. Frequently, such A/B switches can be “tricked” into releasing both buttons at once—no signal emerges—and/or engaging both buttons at once—Chs. 1 and 2 come through both loudspeaker and headphones. This accidental facility can be helpful, and can, of course, be achieved intentionally through a variety of means. Optionally and helpfully, one can “tag” the several characters' dialogue separately, so a given character's dialogue can be automatically directed to one output and not another. Such technology and circuitry are already well-known even in the analog recording realm and need not be recapitulated in detail here; for example, modern VCRs can encode such a tag at the beginning of a recorded segment, to be sought out automatically later, and the “chapter” or “scene” function already present on most commercial DVDs already serves to mark points in a program, and thereby to identify chunks of material; these already-extant functions are easily adaptable to trigger a desired result, such as changing the output from one destination (e.g., loudspeakers) to another (e.g., headphones). Computers and other digital platforms clearly can make and access such “tags” as well, and thereby also use such “tags” to perform functions automatically.

This “all-dialogue-on-one-channel” option can be practiced with the other sounds on the recording (the music and effects, or “M&E”) on the other stereo channel, or all of the audio—both dialogue and M&E—can be on a single channel. Thus, the key feature is that the various characters' dialogue be separately accessible, not necessarily separately recorded, although the latter situation certainly facilitates the former.

The following description is of a likely application of the invention to the language-training arena; it is readily seen that the same technology and methods apply to the musical arena, as well. The preferred source material for language training would be audio or audio-visual material involving conversations or other vocal interactions between characters.

Such source material—the “Piece”—is recorded—“encoded”—onto a storage medium, for example a DVD, having multiple audio channels, in such a manner that at least one audio channel—channel A—contains one character's dialogue, and at least one other audio channel—channel B—does not contain that character's dialogue. The student routes the audio channels via switching circuitry/devices/software commands—more about this particular feature later—so as to direct channel A to headphones and channel B to loudspeakers. The student thus hears all of the dialogue and M&E of the Piece through the loudspeakers, save only for the dialogue of the character the student is “playing” in this little theatrical interaction; this character's dialogue the student hears through headphones, being prompted thereby to speak that dialogue in response to the dialogue of the other character(s) in the piece.

In a situation where one only has two audio channels to work with, such as conventional stereo VCRs or audiocassette decks or even, for the nostalgically inclined, LPs or ¼″ tape, the second channel would contain all the audio information except for that one character's dialogue: the dialogue of any other characters plus the M&E information. M&E can alternatively be included on the first channel instead, or on both, as desired. There is an advantage to having channel A be the left channel, in that when a mono headphone plug is inserted into a stereo headphone jack, it accesses the left channel, thereby obviating the need for an adapter plug. Where more than two audio channels are available—most relevantly DVDs and computer software stored on any medium, but also, for example, multitrack tape configurations like 12-channel Beta audio, 4-channel cassette and reel-to-reel and larger, more capacious tape—one can readily see the advantage of recording as many separate characters' dialogue as possible each on a separate audio channel, and then also recording the M&E on a separate track. With enough channels or memory available, the M&E and the individual characters' dialogue can be recorded in stereo, 5.1, or whatever.

In an application where two or more characters' dialogue is separately accessible, it can thus be possible for a similar number of students to “play” these various characters, and so, for example, a group of ten students could “perform” an ensemble Piece like “The Big Chill”, with one student hearing Glenn Close's dialogue through her headphones, another hearing William Hurt's dialogue through his headphones, and so on, with the loudspeaker audible to all ten students primarily carrying the film's Motown soundtrack. In practice, however, it will generally be found to be helpful to retain at least part of the original dialogue in the interaction, i.e., to have fewer participant students than the total number of characters in the Piece; this provides all of the students with a jointly-heard reference point to play off of. Of course, this technology need not be used for language training purposes: it can be used in the same way to permit teachers and students to simply “play” characters, for acting training purposes or simply for entertainment.

A variant of this scheme is to have the student speak his or her dialogue into a microphone, whose output can be routed through the loudspeakers. The student's dialogue thus emerges from the same source as that of the pre-recorded characters, sharing the tonal characteristics that the loudspeakers impart, and thereby integrating the student's efforts more completely with the original performances.

An important improvement on this variant is to record the student as he or she speaks the prompted dialogue, so as to allow him or her to play back his or her performance and judge its quality, and also to allow switching back and forth between the student's rendition of the dialogue and the original. Of course, this can be achieved with a separate audio or audio-visual recorder of whatever type, but is more attractively arranged in one unit. This is easily achieved with the multitrack tape formats as well as the digital recording options, particularly utilizing a computer, but also with various disc options such as recording CDs and DVDs. Also useful in this application are the hybrid DVD/VCRs now available, which allow one to play the source material on DVD, and record that source material along with the student's performance on the VCR. The previously-mentioned option of having all the sound recorded on one channel easily permits recording the student's efforts on the other stereo channel of any stereo format. Of course, it is also possible to have the playback and/or recording occur on-line.

Also, the now humble-seeming VCR has hidden potential for this application, as well. Modern HiFi Stereo VCRs record their HiFi audio tracks via helical scan heads on the same rotating drum that records the video signals, which produces an effective tape speed 2-3 times as great as the speed of state-of-the-art analog recording-studio tape decks utilizing stationary recording heads, with attendant superior sound quality. However, in order to maintain compatibility with non-HiFi VCRs, sound is also recorded utilizing a stationary recording head which, given the extremely slow actual tape speed of VHS tape, even on SP—a small fraction of audiocassette tape speed—is of fairly abysmal, LoFi sound quality. It is, however, quite adequate for recording conversation and, more importantly, is freely re-recordable; because of the way the HiFi audio tracks are recorded, they cannot be recorded over without mangling the video information. While, for the sake of ordinary consumer convenience, both HiFi and LoFi tracks are normally recorded simultaneously, there is no great feat involved in modifying a HiFi VCR to allow it to record on the LoFi stationary head without at the same time recording on the HiFi heads, and thereby without affecting the video. Thus, the student could listen to one HiFi audio channel, playing “her” character's dialogue (and possibly M&E), through headphones, and to the other HiFi audio channel, playing the other characters' dialogue and M&E, through loudspeakers, and speaking “her” dialogue into a microphone while recording it on the LoFi stationary audio track. Also, prior to the advent of HiFi stereo VCRs, there was a brief flourishing of high-end VCRs that were non-HiFi stereo, i.e, they recorded the audio signals via two lousy stationary heads; obviously, that feature could be rather easily added to current HiFi stereo VCRs with the aforementioned modification.

It can easily be seen how all of these features would also be useful for singalong purposes, as well. The singer listens to the backing track—music and background vocals, the musical equivalent of M&E—through loudspeakers, while he also hears the original (or, at least, a guide) lead vocal through headphones. He normally sings into a microphone, whose signal is directed through the same loudspeakers, but can also be directed to some sort of recording device where it is normally combined with the backing track to make a recording of the full performance. And again, instrumentalists would use these features similarly.

Also useful is the ability to change the speed of the audio on the source material—almost always to slow it down to aid the student in uttering difficult foreign dialogue. In the past, prior to the invention digital audio technology, this was impractical due to the fact that slowing down analog audio lowered it unacceptably in pitch. Digital recording technology, on the other hand, allows audio to be “stretched out” without altering its pitch. While the effect is slightly odd (and, if used in conjunction with video, there is no getting around the fact that people will be moving in slow motion), it is not so weird as to be unduly distracting, and novice students benefit greatly from the added time to pronounce unfamiliar phrases. The same feature could allow a singer to turn any uptempo song into a ballad or vice versa without changing the key, although the slight oddness alluded to may be more bothersome in a musical context. This feature is practicable on any digital format, such as DVD or on a computer.

However, ordinary, commercially-available DVD players will generally not play sound when playing at other than normal speed, and so such slowed-down programming must be recorded in its slowed-down form onto the DVD, rather than being able to be derived or synthesized from the regular-speed version of the program. This necessitates the use of twice as much storage capacity to have both regular- and slow-speed versions of a program on a DVD, and multiples if one is to have a variety of slowed-down speeds, all of which can prove limiting. Alternatively and, in this regard, preferably, the software that permits slowed-down digital programming to be rendered and recorded onto a DVD can be incorporated into a computer or other device, so as to allow a multiplicity of slower-speed-renditions-with-sound to be derived from a single speed of source program (presumably, but not necessarily, “regular” speed).

The digital format also permits the employment of particularly detailed menus for the selection of various options, such as which character to “play”, choosing a regular or slow mode, how many students will participate, and so on. Such a menu could, for example, allow choosing: character 1's dialogue being routed to the student's headphone at regular speed, or slowed down, or character 2's dialog being routed to the student's headphone at regular speed, or slowed down; this selection could be accomplished by choosing successive “either/or” options, or from a list of combined options, e.g., from a list of four combinations in this example.

Practicing the invention on a computer represents a particularly handy and compact embodiment. Modern computers are easily adapted to practicing this invention, as they nearly all have monitors, speakers, DVD/CD drives and multimedia capability, with microphone input(s) and headphone output(s), and USB cameras are increasingly widespread, as well, permitting even the video recording of a practitioner's efforts. There are many available recording programs that will allow the recording (and playback) of the student's efforts; alternatively, new software can be written to integrate all of the functions of this invention. Such a software-based iteration of this invention will likely prove to be the most successful embodiment of this invention, given the pervasiveness of computers in modern society, and the fact that most of them have most or all of the hardware required for practicing this invention; this would mean that all that would be required to add would be software, a significant savings and convenience. In such an embodiment, the functions of almost all of the components in FIGS. 1 and 2 would be accomplished by means of software. Of course, other digital platforms, such as Digital Video Recorders like TiVo and ReplayTV, or accessing and recording over the internet, including via web sites and person-to-person, could be used to practice the invention, too. Furthermore, the invention could be practiced via television or even radio, although the effectiveness of the invention is diminished without video or other images.

A further embellishment is to employ a variation on voice-recognition technology to compare the user's efforts with the original performance, delivering a score or graph or other comparison of the two, so as to give the user a means for evaluating his or her performance. For language applications, this scoring would be based on a number of different factors, such as pronunciation, inflection, phrasing and timing, and also the accuracy of the student's lip-synching of his or her performance to that in the original performance template.

Voice-recognition technology can also be employed to recognize different voices, instruments or other sounds in the original performance template, for the purpose of, for example, suppressing and re-routing a particular voice, instrument or sound automatically.

Another particularly handy and compact embodiment involves uniting all of the components into one unit. Just as there are already TV/VCR and TV/DVD combos, one could readily combine a television, DVD recorder (or DVD player plus VCR, or DVR, or computer) and microphone(s) along with a mixer and a remote control that could control all of the functions. Such a remote control could include “one-touch” controls that could effect multiple commands at one time; for example, pressing a button labeled “Character 1” might start the program playing, with the dialogue of a first character being directed to headphones and all other sound directed to loudspeaker, while simultaneously activating a record function and recording the student's performance of “Character 1's” dialogue. A variation on such a remote control would be to utilize a commercially available “learning” remote control, which can be “taught” various commands. Of course, these same “one-touch” control functions could be performed via menu selections in a DVD player or computer, for example.

A simple process for recording a learning video for the use of this invention would involve the video recording of two speakers reciting dialogue. When speaker 1 speaks, she would be shot over speaker 2's shoulder (or simply by speaker 2, from his POV), and her dialogue would be recorded, paying special attention to having the speaker oriented so that her lips are fully visible, to help the student “lip-sync” the lines later on. One would then stop recording, reposition the camera to shoot over speaker 1's (or, again, have speaker 1 shoot from her POV), and record speaker 2 speaking, with his dialogue likewise recorded. One would then reposition the camera to record speaker 1's next lines, etc. It is helpful to employ two separate microphones (one for each speaker), rather than relying on a video camera's built-in microphone, and these microphones could both be connected to the video camera's microphone input with the aid of a “Y” cord or plug. As an alternative to this “editing in the camera” approach, one could employ two cameras, each aimed over one speaker's shoulder at the other speaker, and the speakers would speak their dialogue in real time, with their dialogue likewise recorded, fed to a single channel or separate channels while a director switched between the video feeds; of course, the switching would not have to be done “live”, and the two characters' footage could be edited afterwards.

I claim:

1. A training device on which audio program information can be recorded on at least one channel, with the facility to access at least one portion of the audio program information separately from the rest, whereby the rest of the audio program information is played back in such a way as to be generally audible while said at least one portion is suppressed or attenuated or played back so as to be audible only to the user, with the user being prompted by said at least one portion to perform it audibly.

2. The training device of claim 1, wherein said audibly performed portion is able to be separately recorded.

3. The training device of claim 1, wherein it is possible to play such audio information back at other than normal speed, including slower speed.

4. The training device of claim 3, wherein it is possible to play such audio information back at other than normal speed, including slower speed, without having to record each speed variation separately.

5. The training device of claim 1, comprising also visual information synchronized with said audio information.

6. The training device of claim 5, comprising also subtitles displayed with said visual information, said subtitles rendering some or all of any dialogue, lyrics or music contained in said audio information.

7. The training device of claim 6, further comprising taking words from said subtitles for use in vocabulary training.

8. The training device of claim 7, wherein the vocabulary training is the “hangman” game.

9. The training device of claim 6, wherein the subtitles are generated and/or synchronized to the visual information by use of voice-recognition technology.

10. The training device of claim 1, wherein said audio program information is re-recorded in conjunction with further audio information, so that said audio program information and said further audio information are re-recorded together onto at least one channel, and said further audio information is recorded separately onto at least one other channel, said audio program also being synchronized with visual information.

11. The training device of claim 10, further comprising a microphone or other transducer capable of receiving said audible user performance and conveying it to an audio- or audio-visual-recording device, permitting the recording of said audible user performance in conjunction with said audio program information, said further audio information and said synchronized video information.

12. The training device of claim 11, further comprising the ability to play back said audio and video information at other than normal speed, and further comprising the ability to generate and display subtitles transcribed from any dialogue in said audio information.

13. A microphone and headphone combination, wherein the cables of the headphone and the microphone are physically joined up to a certain point near the user, at which point the respective cables diverge so as to allow sufficient flexibility in positioning the microphone while also minimizing the potential for cord tangling.

14. A method of teaching involving a student interacting with an audio program, comprising recording the audio program on at least one channel of a storage system with the facility to access at least one portion of the audio program separately from the rest, whereby the rest of the audio program is played back so as to be generally audible while said at least one portion is suppressed or played back so as to be audible only to the user, with the student being prompted by said at least one portion to speak it audibly, said audible speech being able to be separately recorded.

15. The method of claim 14, further comprising: encoding the audio program by transferring it from the storage system to a first channel of a second storage system, while adding further sound to both said first channel and a second channel; when the thus encoded audio program is played back, said first and second channels are switchably fed to a headphone and an audio mixer, such that either channel can be fed to the headphone and the other to an input of the audio mixer, with the output from the audio mixer being fed to one or more loudspeakers, said headphone providing the user with prompting of content to be performed by the user into said microphone, and said loudspeakers providing the additional content of the encoded audio program.

16. The method of claim 15, further comprising a video program synchronized with the audio program.

17. The method of claim 16, further comprising a microphone, whose output is fed to another input of the audio mixer, thereby permitting the incorporation of the user's performance into the output fed to the loudspeakers.

18. The method of claim 17, further comprising a recording device to permit the recording of the user's performance, either alone or in conjunction with some or all of the encoded audio program.

19. The method of claim 18, wherein the recording device to permit the recording of the user's performance is an audio-visual recording device, permitting both audio and visual recording of the user's performance.

20. The method claim of claim 19, further comprising the facility of playing said audio program at other than normal speed, including slower speed, permitting the adaptation of the speed of the prompting audio program to the student's abilities, and further comprising the ability to generate and display subtitles of transcriptions of any dialogue in said audio program, to further prompt and aid the student.
